(19) United States
(12) Patent Application Publication
(10) Pub. No.: US 2013/0132775 A1
(43) Pub. Date: May 23, 2013

(54) DIAGNOSTIC MODULE DELIVERY DEVICE, DIAGNOSTIC MODULE DELIVERY METHOD, AND RECORDING MEDIUM

(71) Applicant: FUJITSU LIMITED, Kawasaki (JP)

(72) Inventor: Kunihito ONOUE, Kawasaki (JP)

(73) Assignee: FUJITSU LIMITED, Kawasaki (JP)

(21) Appl. No.: 13/742,897

(22) Filed: Jan. 16, 2013

Related U.S. Application Data
(63) Continuation of application No. PCT/JP2010/064638, filed on Aug. 27, 2010.

(51) Int. Cl. G06F 11/07

(52) U.S. Cl. CPC G06F 11/076
USPC 714/33

(57) ABSTRACT

A diagnostic module delivery server includes a diagnostic selecting unit that reads a failure rate of a component from a component database that stores therein the failure rates of the components obtained based on the maintenance history of the components constituting a maintenance target server. Furthermore, the diagnostic selecting unit determines whether to diagnose the component in accordance with the result of comparing the read failure rate of the component and a failure rate reference value that is stored in a diagnostic reference value database. Furthermore, the diagnostic module delivery server transmits, to the maintenance target server, a diagnostic module that is used to diagnose the component in which it is determined, by the diagnostic selecting unit, that the diagnostics is to be performed.

### CROSS-REFERENCE TO RELATED APPLICATION

This application is a continuation application of International Application PCT/JP2010/064638, filed on Aug. 27, 2010, and designating the U.S., the entire contents of which are incorporated herein by reference.

### FIELD

The embodiments discussed herein are directed to a diagnostic module delivery device, a diagnostic module delivery method, and a diagnostic module delivery program.

### BACKGROUND

Conventionally, maintenance work is usually performed on devices, such as servers or personal computers (PCs), by maintenance technicians who periodically go to locations where the devices are installed and execute diagnostic modules, which are previously determined by a maintenance procedure manual or the like, on the devices, or the like, that are targeted for maintenance.

With related maintenance work, because there are differences in the operational or maintenance histories of components constituting a device that is targeted for maintenance, changing the components that are targeted for diagnostics or changing diagnostic content is not considered.

In contrast, in recent years, test program scheduling is determined by defining, using a bath tub curve, failure rates including initial failure rates, random failure rates, useful life failure rates, and the like of components constituting a maintenance target device, i.e., a device targeted for maintenance, and by estimating the fault rates of the components from the operational history of each component.

Patent Document 1: Japanese Laid-open Patent Publication No. 10-301799

However, because the bath tub curve, used in the related technology, of a fault rate of a component is a standard statistical value obtained based on an initial failure, a random failure, or a useful life failure of various components, there may sometimes be a case in which the fault rate obtained based on maintenance history of a component in a maintenance target device is not appropriately given. Consequently, if the related technology that uses a bath tub curve is used to determine whether to perform the diagnostics of components, it may sometimes not be appropriately determined whether components are diagnosed.

### SUMMARY

According to an aspect of the embodiments, a diagnostic module delivery device includes: a memory; and a processor coupled to the memory, wherein the processor executes a process including: reading, from a component database that stores therein values related to the reliability of components and obtained based on maintenance history of the components constituting a device that is targeted for maintenance, a value related to the reliability of a component of the device targeted for the maintenance, and determining whether to diagnose the component in accordance with a result of comparing the read value related to the reliability and a previously set threshold; and transmitting, to the device targeted for the maintenance, a diagnostic module that is used to diagnose the component in which it is determined, at the determining, that diagnostic is to be performed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating the overall configuration of a diagnostic module delivery system according to an embodiment;

FIG. 2 is a schematic diagram illustrating the configuration of a diagnostic module delivery server, a component database, and a maintenance target server;

FIG. 3 is a table illustrating an example of a diagnostic reference value database;

FIG. 4 is a table illustrating an example of a diagnostic module list database;

FIG. 5 is a table illustrating an example of a component database;

FIG. 6 is a table illustrating an example of configuration information related to the maintenance target server;

FIG. 7 is a table illustrating an example of operational information and environmental information;

FIG. 8 is a table illustrating an example of maintenance history;

FIG. 9 is a flowchart illustrating the flow of an operation of the diagnostic module delivery server and the maintenance target server according to the embodiment;

FIG. 10 is a flowchart illustrating the flow of an example of a first process performed by the maintenance target server;

FIG. 11 is a flowchart illustrating the flow of an example of the first process performed by the diagnostic module delivery server;

FIG. 12 is a flowchart illustrating the flow of an example of the first process performed by the diagnostic module delivery server;

FIG. 13 is a flowchart illustrating the flow of an example of the first process performed by the diagnostic module delivery server;

FIG. 14 is a flowchart illustrating the flow of an example of the first process performed by the diagnostic module delivery server;

FIG. 15 is a flowchart illustrating the flow of an example of a second process performed by the maintenance target server; and

FIG. 16 is a flowchart illustrating the flow of an example of the second process performed by the diagnostic module delivery server.

### DESCRIPTION OF EMBODIMENTS

Preferred embodiments will be explained with reference to accompanying drawings. The present invention is not limited to the embodiments.

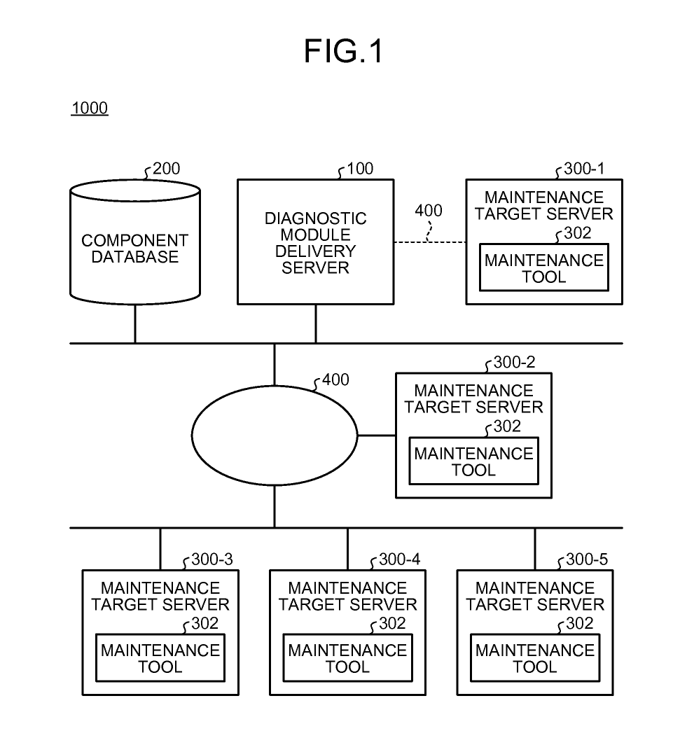

FIG. 1 is a schematic diagram illustrating the overall configuration of a diagnostic module delivery system according to an embodiment. As illustrated in FIG. 1, a diagnostic module delivery system 1000 includes a diagnostic module delivery server 100, a component database 200, and a plurality of maintenance target servers 300-1 to 300-5. The diagnostic module delivery server 100 is an example of a diagnostic module delivery device. Furthermore, the maintenance target servers 300-1 to 300-5 are examples of devices, such as servers or PCs, targeted for maintenance.

The diagnostic module delivery server 100 is a server that selects a diagnostic module to be executed in the maintenance target servers 300-1 to 300-5 and that delivers the selected diagnostic module to the maintenance target servers 300-1 to 300-5. In general, the diagnostic module delivery server 100 is a server constructed in the maintenance division or the support division in the system operation in a server vendor or constructed in a company that provides a similar service to that provided by a server vendor. The diagnostic module delivery server 100 is established in an environment in which communication is available with maintenance target servers via a network, such as the Internet, an intranet, a wireless local area network (LAN), or a dedicated line. In the embodiment, the diagnostic module delivery server 100, the component database 200, and the maintenance target servers 300-2 to 300-5 are connected with each other by a network 400 via the Internet. Furthermore, the diagnostic module delivery server 100 is connected to the maintenance target server 300-1 by the network 400 via a dedicated line.

The component database 200 is a database in which information on components constituting the maintenance target servers 300-1 to 300-5 is accumulated. Furthermore, the component database 200 stores therein failure rate data of components after the components constituting the maintenance target servers 300-1 to 300-5 are operated, useful life data of components if the components have their useful life, and the like. In the embodiment, the component database 200 is connected to the diagnostic module delivery server 100 via the network 400; however, the component database 200 may also be a database that is directly connected to the diagnostic module delivery server 100.

The maintenance target servers 300-1 to 300-5 are servers that are targeted for maintenance/operation service and that execute a diagnostic module delivered from the diagnostic module delivery server 100. In general, the maintenance target servers 300-1 to 300-5 are servers operated by a user. Each of the maintenance target servers 300-1 to 300-5 has a maintenance tool 302 that executes a diagnostic module. In the following, the diagnostic module delivery server 100, the component database 200, and the maintenance target servers 300-1 to 300-5 will be described in detail. Each of the maintenance target servers 300-1 to 300-5 includes the same maintenance tool 302; therefore, in the following, only the description of the maintenance target server 300-2 will be described as a representative example.

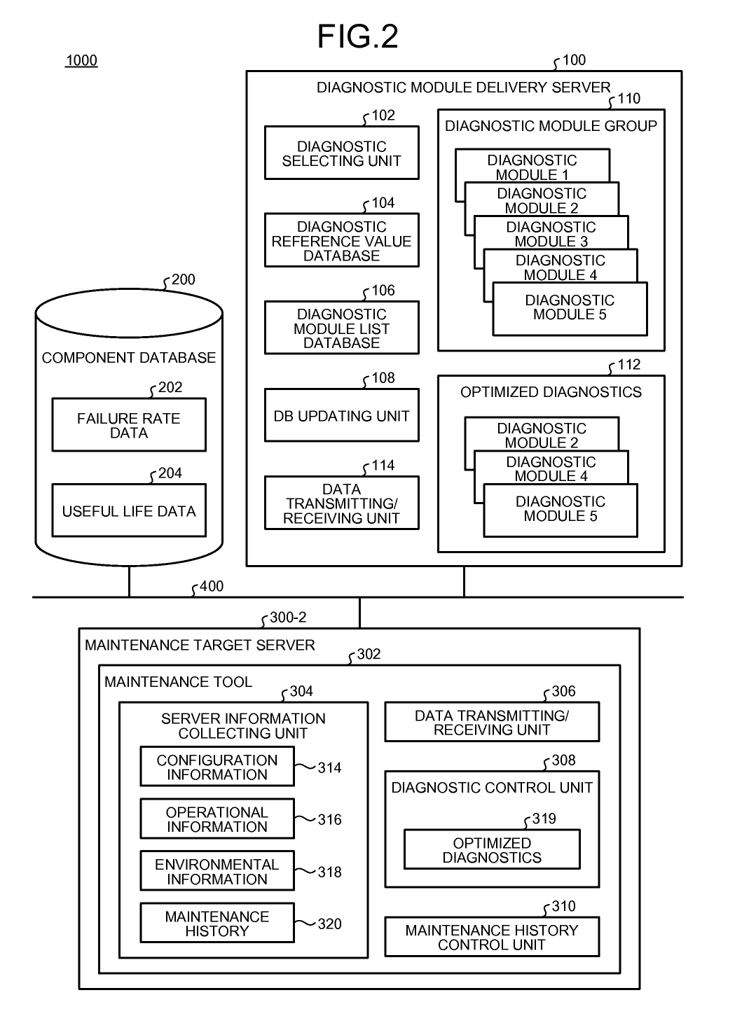

FIG. 2 is a schematic diagram illustrating the configuration of the diagnostic module delivery server 100, the component database 200, and the maintenance target server 300-2. As illustrated in FIG. 2, the diagnostic module delivery server 100 includes a diagnostic selecting unit 102, a diagnostic reference value database 104, a diagnostic module list database 106, a database (DB) updating unit 108, a diagnostic module group 110, an optimized diagnostics 112, and a data transmitting/receiving unit 114.

The diagnostic selecting unit 102 determines whether to perform diagnostics of components constituting the maintenance target servers 300-1 to 300-5 based on server information sent from the maintenance target servers 300-1 to 300-5, information obtained from the component database 200, and the diagnostic reference value database 104. Furthermore, if the diagnostic selecting unit 102 performs the diagnostics, the diagnostic selecting unit 102 selects the optimum diagnostics from the diagnostic module group 110.

The diagnostic reference value database 104 contains reference value data used to determine whether to perform diagnostics on each component in the component database 200. The diagnostic module list database 106 is a list in which diagnostic modules associated with components are defined. In addition to the list of modules, diagnostic modules that are executed in order to evaluate both track records of failure detection of diagnostic modules and diagnostic efficacy of the components are defined in the diagnostic module list database 106. The diagnostic reference value database 104 and the diagnostic module list database 106 will be described in detail later.

The DB updating unit 108 receives, from each of the maintenance target servers 300-1 to 300-5, the diagnostic result executed in the maintenance tool 302 in each of the maintenance target servers 300-1 to 300-5 and updates the component database 200. The diagnostic module group 110 is an assembly of various diagnostic modules with respect to components constituting the maintenance target servers 300-1 to 300-5. The optimized diagnostics 112 is an assembly of diagnostic modules selected from the diagnostic module group 110 by the diagnostic selecting unit 102. The optimized diagnostics 112 is optimized for the maintenance target servers 300-1 to 300-5. The data transmitting/receiving unit 114 transmits and receives various kinds of data between the component database 200 and the maintenance target servers 300-1 to 300-5.

The component database 200 includes failure rate data 202 and useful life data 204 as values of the reliability of components constituting the maintenance target servers 300-1 to 300-5. The failure rate data 202 and the useful life data 204 are values obtained based on maintenance histories of components constituting the maintenance target servers 300-1 to 300-5. The component database 200 will be described in detail later.

The maintenance target server 300-2 includes the maintenance tool 302. The maintenance tool 302 is a maintenance tool used in the maintenance work. The maintenance tool 302 includes a server information collecting unit 304, a data transmitting/receiving unit 306, a diagnostic control unit 308, and a maintenance history control unit 310. The maintenance tool 302 may also be executed as a program installed in the maintenance target server 300-2, or alternatively, may also be transmitted from the diagnostic module delivery server 100 via the network 400 and then executed. Furthermore, the maintenance tool 302 may also be carried by a maintenance technician as a program stored in, for example, a CD medium or a universal serial bus (USB) memory and then be executed.

The server information collecting unit 304 collects server information needed to perform diagnostic optimization from the maintenance target server 300-2. The server information collecting unit 304 collects, as server information, configuration information 314, operational information 316, environmental information 318, and maintenance history 320. The configuration information 314, the operational information 316, the environmental information 318, and the maintenance history 320 will be described in detail later. The data transmitting/receiving unit 306 transmits and receives various kinds of data to and from the diagnostic module delivery server 100. The diagnostic control unit 308 receives optimized diagnostics 319 from the diagnostic module delivery server 100 and controls the execution of diagnostics. The maintenance history control unit 310 updates, as maintenance history of the maintenance target server, the date and time of maintenance work, replacement component information, information on executed diagnostic modules, and the like.

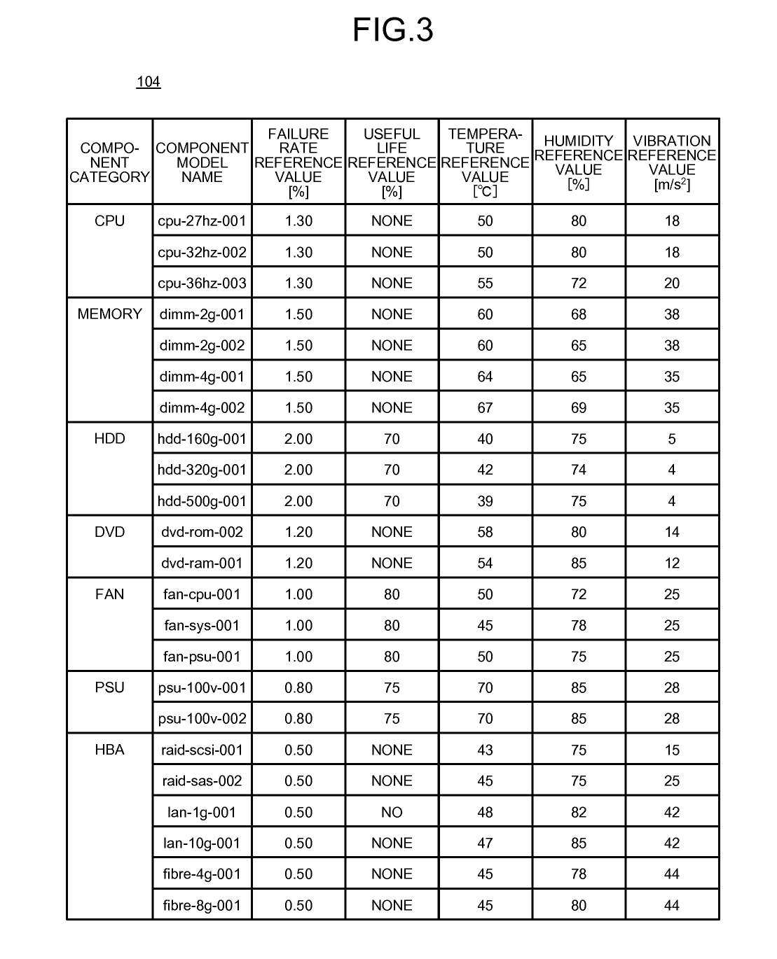

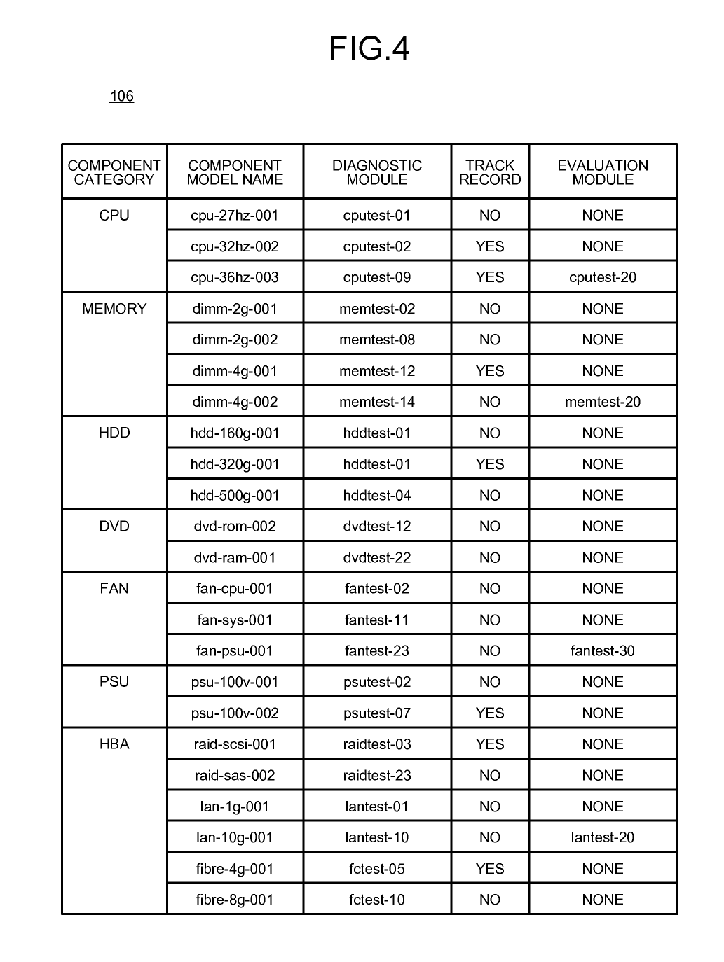

In the following, the diagnostic reference value database 104 and the diagnostic module list database 106 will be described in detail. FIG. 3 is a table illustrating an example of a diagnostic reference value database. FIG. 4 is a table illustrating an example of a diagnostic module list database. As illustrated in FIG. 3, the diagnostic reference value database 104 stores therein, for each component category, a component model name, a failure rate reference value, a useful life reference value, a temperature reference value, a humidity reference value, and a vibration reference value. The component category mentioned here indicates the categories of the components constituting, for example, a server or a PC. The component model name indicates the model names of individual components constituting the server or the PC. The failure rate reference value indicates the reference value of the failure rate (%) of each component that appears in the component model name of each component category and that is targeted for diagnostics. Components having a value equal to or greater than the corresponding failure rate are targeted for diagnostics. The useful life reference value indicates, for the category of components having that useful life, the depletion rate (%) of the useful life targeted for diagnostics. The components having a value equal to or greater than the depletion rate are targeted for diagnostics. If a component has no available reference value, this state is represented by “none”. For example, for a component having the useful life with a power-on time period of 60 months and a power-on count of 7,000, the component is targeted for maintenance when the power-on time period exceeds 42 months or the power-on count exceeds 4,900 counts, which is 70% of its useful life.

The temperature reference value indicates the resistance of temperature for each component model name listed under each component category and defines the temperature (° C.) of an installation environment targeted for maintenance. The humidity reference value indicates the resistance of humidity of each component model name listed under each component category and defines the humidity (%) of an installation environment targeted for maintenance. The vibration reference value indicates the resistance of vibration of each component model name listed under each component category and defines the vibration (m/s²) in an installation environment targeted for maintenance. In the diagnostic reference value database 104 in the embodiment, an example has been given in which the same failure rate reference value is stored for a plurality of component model names in each component category; however, the example is not limited thereto. Each of the cpu-27 hz-001, cpu-32 hz-002, and cpu-36 hz-003 listed under the component model name of the component category CPU stores therein a failure rate reference value 1.30; however, for example, a different failure rate reference value may also be used for each component model name.

Furthermore, as illustrated in FIG. 4, the diagnostic module list database 106 stores therein, for each component category, a component model name, a diagnostic module, a track record, and an evaluation module. The component category mentioned here indicates the categories of the components constituting a server or a PC. The component model name indicates the model names of individual components constituting the server or the PC. The diagnostic module indicates a diagnostic module associated with a component model name. The track record indicates the track record of the detection of a failure of a component with respect to a diagnostic module. If a track record is present, this state is represented by “yes”, whereas if no track record is present, this state is represented by “no”. The evaluation module indicates the diagnostic module that is selected as an evaluation target.

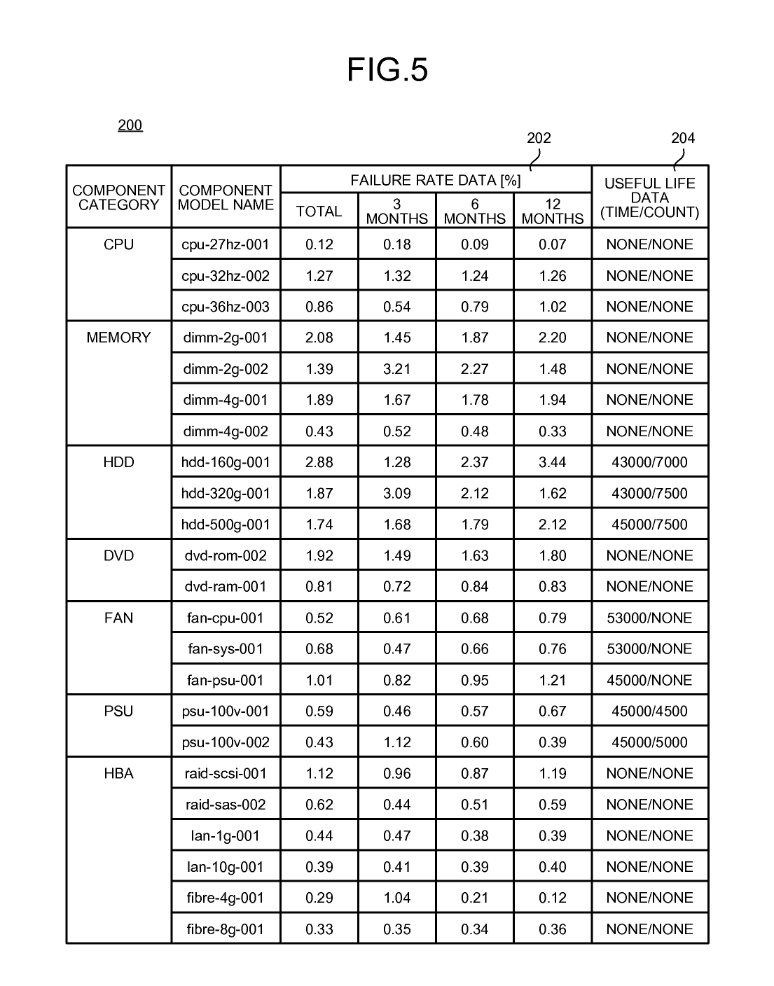

In the following, the component database 200 will be described in detail. FIG. 5 is a table illustrating an example of a component database. As illustrated in FIG. 5, the component database stores therein, for each component category, a component model name, the failure rate data 202, and the useful life data 204. The component category mentioned here indicates the categories of components constituting a server or a PC. The component model name indicates the model names of individual components constituting the server or the PC. The failure rate data (Total) is the total failure rate of the components and is indicated by a percentage. The failure rate data (3 months) indicates the failure rate (percentage) after three months have elapsed since the start of the operation of each component. The failure rate data (6 months) indicates the failure rate (percentage) after 6 months have elapsed since the start of the operation of each component. The failure rate data (12 months) indicates the failure rate (percentage) after 12 months have elapsed since the start of the operation of each component. The useful life data (time/count) indicates the useful life of component represented by a power-on time period and a power-on count. If a component has no available life, it is represented by “none”.

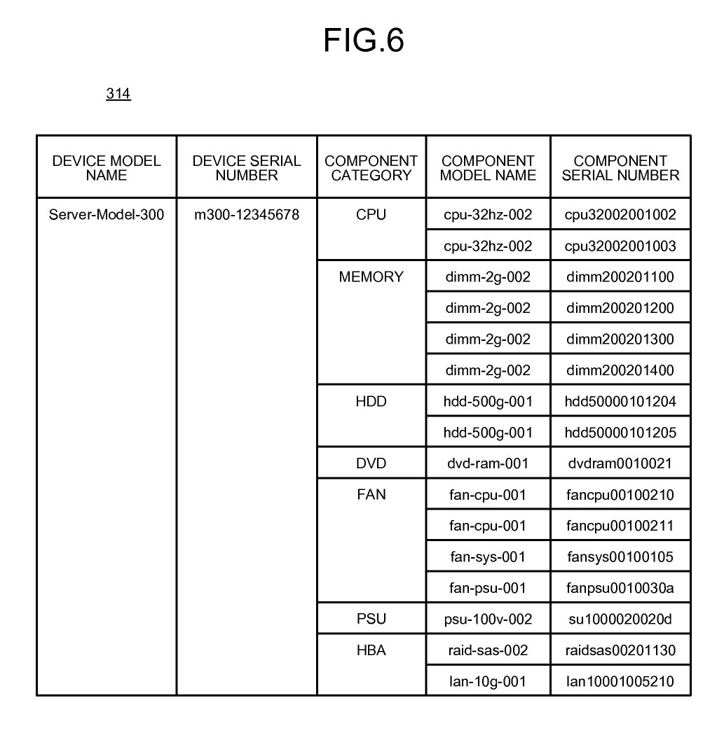

In the following, the configuration information 314, the operational information 316, the environmental information 318, and the maintenance history 320 will be described in detail. FIG. 6 is a table illustrating an example of configuration information related to the maintenance target server 300-2. As illustrated in FIG. 6, for each device model name, the configuration information 314 stores therein a device serial number, a component category, a component model name, and a component serial number. The device model name mentioned here indicates the model name of a maintenance target server or a PC. The device serial number indicates the serial number of the maintenance target server or PC. The component category indicates the categories of the components constituting the maintenance target server or the PC. The component model name indicates the model names of individual components constituting the maintenance target server or the PC. The component serial number indicates the serial number of individual components constituting the maintenance target server or the PC.

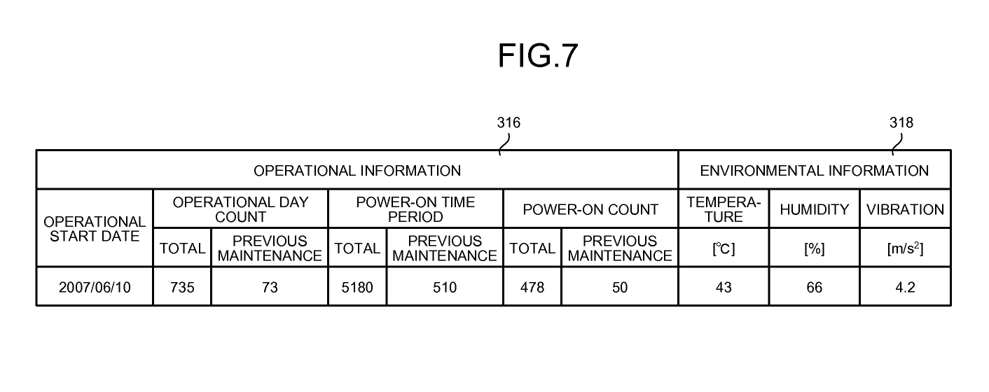

FIG. 7 is a table illustrating an example of the operational information 316 and the environmental information 318. As illustrated in FIG. 7, the operational information 316 stores therein an operational day count, a power-on time period, and a power-on count, which are associated with the operational start date. Furthermore, the environmental information 318 stores therein temperature, humidity, and vibration. The operational start date mentioned here indicates the date at which the operation of a maintenance target server or a PC is started. The operational day count (Total) indicates the total number of days for which the maintenance target server or the PC has been operated. The operational day count (previous maintenance) indicates the day count for which the maintenance target server or the PC has been operated since the previous maintenance. The power-on time period (Total) indicates the total time period for which the power supply of the maintenance target server or the PC has been turned on since the previous maintenance. The power-on time period (previous maintenance) indicates the time period for which the power supply of the maintenance target server or the PC has been turned on since the previous maintenance. The power-on count (Total) indicates the total count for which power supply of the maintenance target server or the PC has been turned on. The power-on count (previous maintenance) indicates the count for which the power supply of the maintenance target server or the PC has been turned on since the previous maintenance. The temperature (° C.) indicates the temperature information on the inside of the maintenance target server or the PC. The humidity (%) indicates the humidity information on the inside of the maintenance target server or the PC. The vibration (m/s²) indicates the vibration information on the inside of the maintenance target server or the PC.

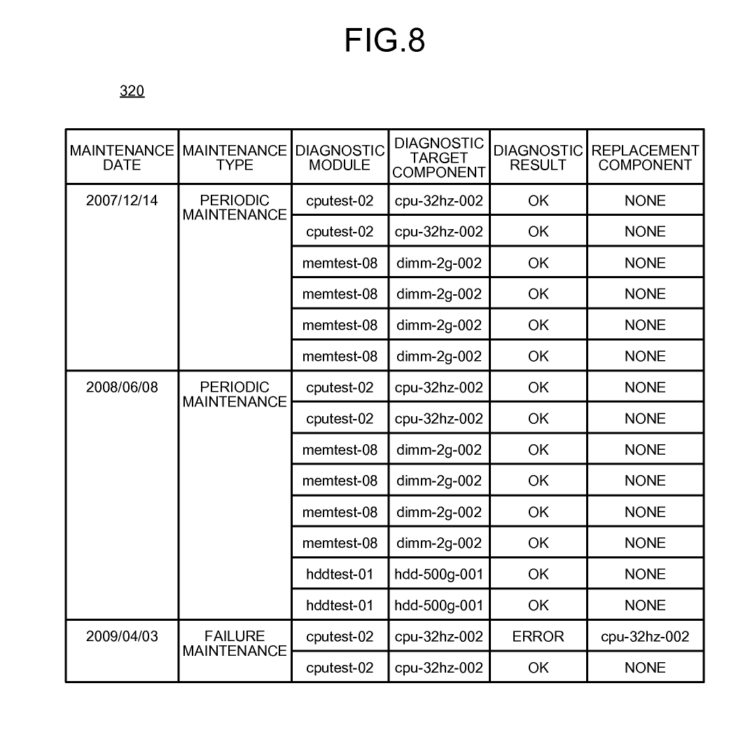

FIG. 8 is a table illustrating an example of the maintenance history 320. As illustrated in FIG. 8, the maintenance history 320 stores therein a maintenance type, a diagnostic module, a diagnostic target component, the diagnostic result, and a replacement component in association with a maintenance date. The maintenance date indicates the date at which maintenance work is performed. The maintenance type indicates the type of maintenance work, i.e., periodic maintenance or failure maintenance. The diagnostic module indicates the name of the diagnostic module executed during the maintenance work. The diagnostic target component indicates the target component for diagnostics executed during the maintenance work. The diagnostics indicates, by using OK (normal end) or ERROR (error detection), the result of diagnostics executed during the maintenance work. The replacement component indicates the component that is replaced in the maintenance work. If replacement is not performed, this state is represented by “none”.

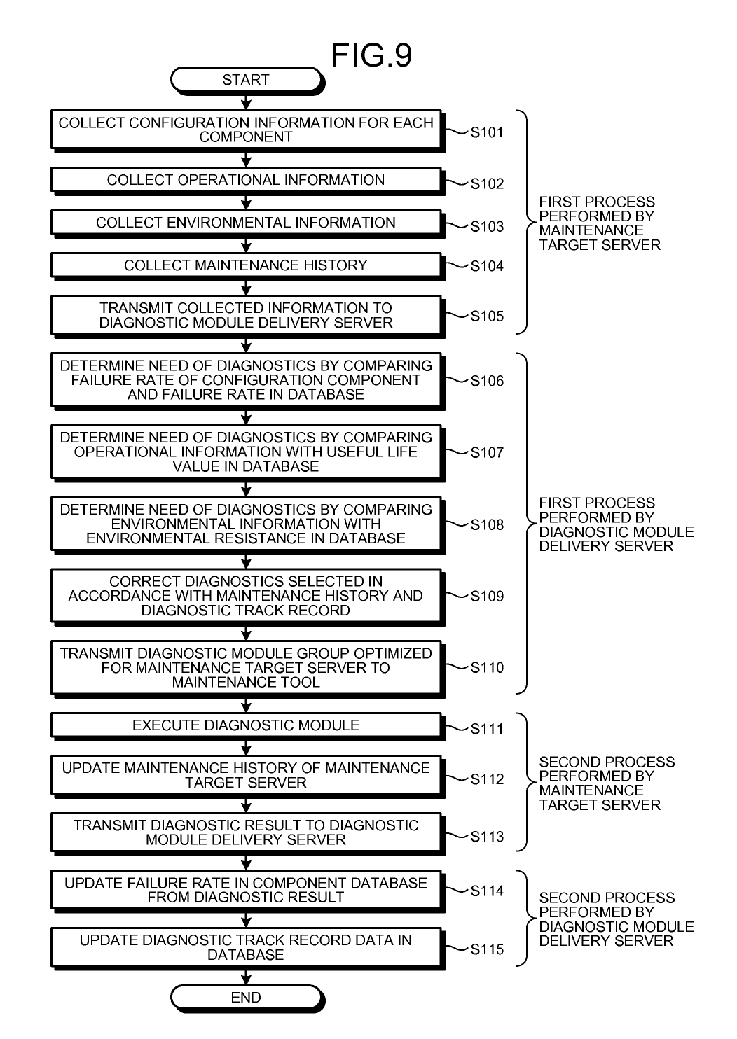

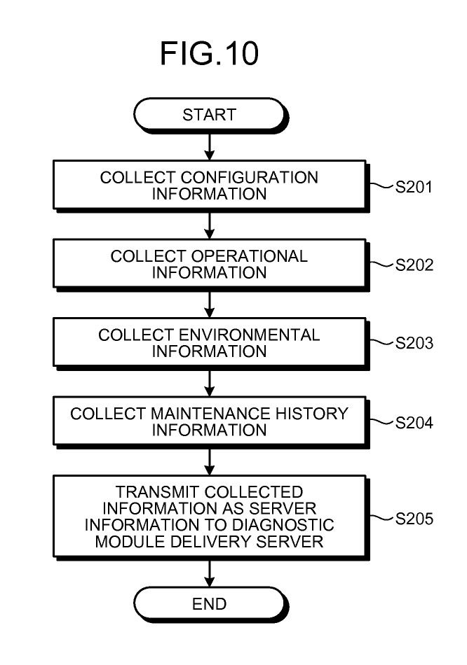

In the following, the operation of the diagnostic module delivery server 100 and the maintenance target server 300-2 according to the embodiment will be described. FIG. 9 is a flowchart illustrating the flow of an operation of the diagnostic module delivery server 100 and the maintenance target server 300-2 according to the embodiment. The flowchart illustrated in FIG. 9 represents the overall operation of the diagnostic module delivery server 100 and the maintenance target server 300-2. The operation of the diagnostic module delivery server 100 and the maintenance target server 300-2 will be described in detail later with reference to FIGS. 10 to 16.

As illustrated in FIG. 9, first, the server information collecting unit 304 collects the configuration information 314 in the maintenance target server 300-2 (Step S101). The configuration information 314 mentioned here is configuration information at the component level of the maintenance target server 300-2. Specifically, the configuration information 314 contains, for example, the model name of the central processing unit (CPU), the model name of the memory, the model name of the hard disk drive (HDD), the model name of the compact disc (CD) or the digital versatile disc (DVD), the model name of the host bus adapter (HBA), and the like, which are installed in the maintenance target server 300-2.

Then, the server information collecting unit 304 collects the operational information 316 on the maintenance target server 300-2 (Step S102). The operational information 316 contains, for example, the time period that has elapsed since the start of the operation of the maintenance target server 300-2, the total power-on time period, the power-on count, and the like.

Then, the server information collecting unit 304 collects the environmental information 318 on the maintenance target server 300-2 (Step S103). The environmental information 318 contains, as information on the environment in which the maintenance target server 300-2 is set up, for example, the temperature, humidity, and vibration of the maintenance target server 300-2.

Then, the server information collecting unit 304 collects the maintenance history 320 of the maintenance target server 300-2 (Step S104). As history information related to the maintenance to which the maintenance target server 300-2 has been subjected, the maintenance history 320 contains, for example, the performance date of the maintenance, work content, and the diagnostic result.

Then, the data transmitting/receiving unit 306 transmits the collected server information to the diagnostic module delivery server 100 via the network 400 (Step S105). The processes performed at Steps S101 to S105 correspond to a first process performed by the maintenance target server 300-2.

If the diagnostic selecting unit 102 receives server information from the maintenance target server 300-2, the diagnostic selecting unit 102 determines, based on the configuration information 314 contained in the received server information, whether diagnostics is to be performed on the component of the maintenance target server 300-2 (Step S106). Specifically, the diagnostic selecting unit 102 specifies a component used in the maintenance target server 300-2 based on the configuration information 314 and refers to the failure rate of the specified component from the failure rate data 202 in the component database 200. The failure rate data 202 of the component in the component database 200 to be referred to is not a fixed value, a theoretical value, nor a statistical value, but is the actual failure rate of the component that is used when this process is performed. If the failure rate of the component used in the maintenance target server 300-2 exceeds the failure rate reference value in the diagnostic reference value database 104, the diagnostic selecting unit 102 selects a module that is used to diagnose the component from the diagnostic module group 110. The diagnostic selecting unit 102 determines the selection of a diagnostic module from the diagnostic module list database 106. With the processes described above, it is possible, by taking into consideration the actual failure rate of the component constituting a device targeted for maintenance, to appropriately determine whether to diagnose a component.

Then, if any useful life remains for the maintenance target server 300-2, the diagnostic selecting unit 102 determines whether to diagnose a component based on the operational information 316 contained in the received server information (Step S107). Specifically, the diagnostic selecting unit 102 determines, from the useful life data 204 in the component database 200 and the operational information 316, the depletion rate of the useful life of the component. If the depletion rate of the useful life exceeds the useful life reference value in the diagnostic reference value database 104, the diagnostic selecting unit 102 selects, from the diagnostic module group 110, the diagnostic module with which the depletion state of the component can be checked. The diagnostic selecting unit 102 determines the selection of a diagnostic module from the diagnostic module list database 106. With the processes described above, it is possible, by taking into consideration the actual useful life of the component constituting a device targeted for maintenance, to appropriately determine whether to diagnose a component.

Then, based on the environmental information 318 contained in the received server information, the diagnostic selecting unit 102 determines whether to diagnose a component of the maintenance target server 300-2 (Step S108). Specifically, the diagnostic selecting unit 102 checks the environment to which a component is exposed by using the environmental information 318 and compares it with the temperature reference value, the humidity reference value, and the vibration reference value in the diagnostic reference value database 104. If the diagnostic selecting unit 102 determines that the environment to which the maintenance target server 300-2 is exposed exceeds the environmental resistance of the component, the diagnostic selecting unit 102 determines the selection of a diagnostic module from the diagnostic module group 110 for the component. The diagnostic selecting unit 102 determines the diagnostic module from the selection in the diagnostic module list database 106. With the processes described above, it is possible to appropriately determine whether to diagnose a component by taking into consideration the environment factors (a temperature, humidity, and a vibration) of components constituting a device targeted for maintenance.

Then, the diagnostic selecting unit 102 corrects the maintenance history 320 contained in the received server information or corrects diagnostics that is to be selected based on the diagnostic track record (Step S109). For example, the diagnostic selecting unit 102 evaluates, based on the maintenance history 320, a diagnostic module selected in the above procedure and then adds or deletes a diagnostic module. For example, for a component that is subjected to preventive replacement at the previous maintenance and thus still has the useful life, the diagnostic selecting unit 102 releases the selection if the component is selected, based on the operational information and the useful life data, as the target for the diagnostics. Furthermore, if a component that has been replaced at the previous maintenance has a failure rate that is within the reference value but the failure rate exceeds the reference value only at the time of initial operation, the diagnostic selecting unit 102 performs correction by, for example, additionally selecting a diagnostic module. Furthermore, for example, from the diagnostic module list database 106, the diagnostic selecting unit 102 checks if there is a diagnostic module having a track record in which a failure has been detected in a component that is being used and checks the registration state of a diagnostic module of which diagnostic efficacy is desired to be evaluated. Furthermore, if a diagnostic module is registered and if the diagnostic module is not selected by using the module selection method described above, the diagnostic selecting unit 102 additionally selects the diagnostic module. With the processes described above, because the correction performed based on the maintenance history or the diagnostic track record is performed including the failure rate of the replacement component, it is possible to execute needed diagnostics at the best time.

Subsequently, the data transmitting/receiving unit 114 transmits, as an optimized diagnostics, the diagnostic module selected by using the flow described above from the diagnostic module delivery server 100 to the maintenance target server 300-2 via the network 400 (Step S110). The processes at Steps S106 to S110 correspond to a first process performed by the diagnostic module delivery server 100.

Thereafter, the diagnostic control unit 308 executes the diagnostic module received from the diagnostic module delivery server 100 (Step S111). Then, the maintenance history control unit 310 updates the maintenance history of the maintenance target server 300-2 (Step S112). Specifically, if maintenance work on the maintenance target server 300-2 is started and the execution of a diagnostic module is completed, the maintenance history control unit 310 creates a maintenance history by using information, such as date information on the maintenance work, diagnostic module information, diagnostic target component information, the diagnostic result, and the like. Furthermore, if a component in which a failure has been detected by the diagnostics is replaced, the maintenance history control unit 310 recollects the latest configuration information; reflects, in the maintenance history, replacement information on a component that is obtained by comparing the latest configuration information with the configuration information on the component before the replacement; adds it to the maintenance history information stored in the server; and stores it. The maintenance history information is stored in an HDD or a nonvolatile memory in, for example, a maintenance target server as data such that the information can be referred to at the next maintenance work.

Then, as the diagnostic result, the data transmitting/receiving unit 306 transmits, to the diagnostic module delivery server 100, the information on the component targeted for the diagnostics and information indicating whether a failure has been detected (Step S113). The processes at Steps S111 to S113 correspond to a second process performed by the maintenance target server 300-2.

The database (DB) updating unit 108 updates the failure rate data 202 in the component database 200 (Step S114) and updates the diagnostic track record data in the diagnostic module list database 106 (Step S115). The processes at Steps S114 and S115 correspond to a second process performed by the diagnostic module delivery server 100. With the processes described above, it is possible to prevent the name of a replacement component from being input to the component database 200 or the diagnostic module list database 106 from an operation terminal by a maintenance technician at the time of maintenance. Consequently, it is possible to save the trouble of conducting an input operation and also to reduce the possibility of improper diagnostics executed by using incorrect update information that is erroneously input.

As described above, by integrally managing and operating the components, the operation status, the environment state, the maintenance history and the actual failure rate of the maintenance target server 300-2, it is possible to select and execute the diagnostics optimized for the status of a target PC or a server and thus improve the efficiency of diagnostics executed during periodic maintenance.

In the following, a description will be given of an update and an evaluation of a diagnostic module at the time of management and operation of the diagnostic module delivery system 1000 according to the embodiment. If a new component is used in a maintenance target server, component information is added to the component database 200; a diagnostic module associated with the new component is added to the diagnostic module delivery server 100; and the diagnostic module list database 106 is updated. Furthermore, if enhancement is executed on a diagnostic module for an existing component, the diagnostic module for the diagnostic module delivery server 100 and the diagnostic module list database 106 are updated. Furthermore, if it is desired to evaluate the efficiency of enhanced diagnostics, the registration is performed as an evaluation module for the diagnostic module list database 106, and thereby it is possible to maintain a diagnostic function that is effective for a system. As described above, a component database and a diagnostic module can be updated; therefore, it is possible to execute efficient diagnostics conforming to the latest component information and the diagnostic module.

Furthermore, in the embodiment, by changing the data stored in the diagnostic reference value database 104, diagnostics executed by a maintenance target server can be controlled. For example, if a failure rate reference value is decreased, diagnostics is executed on a greater number of components. In contrast, if a failure rate reference value is increased, diagnostics is executed on a smaller number of components that have a particularly high failure rate. Furthermore, for diagnostics of the useful life of a component, it is possible to adjust the period of time between diagnostics by increasing or decreasing the useful life reference value.

In the following, the operation of the diagnostic module delivery server 100 and the maintenance target server 300-2 will be described in detail. FIG. 10 is a flowchart illustrating the flow of an example of a first process performed by the maintenance target server 300-2. As illustrated in FIG. 10, if the maintenance tool 302 in the maintenance target server 300-2 is executed, the server information collecting unit 304 collects the configuration information 314 on the server illustrated in FIG. 6 (Step S201). Then, the server information collecting unit 304 collects the operational information 316 and the environmental information 318 on the maintenance target server 300-2 illustrated in FIG. 7 (Steps S202 and S203). Then, the server information collecting unit 304 collects history information on the maintenance target server 300-2 illustrated in FIG. 8 (Step S204). Subsequently, the data transmitting/receiving unit 306 transmits the collected information as server information to the diagnostic module delivery server 100 (Step S205).

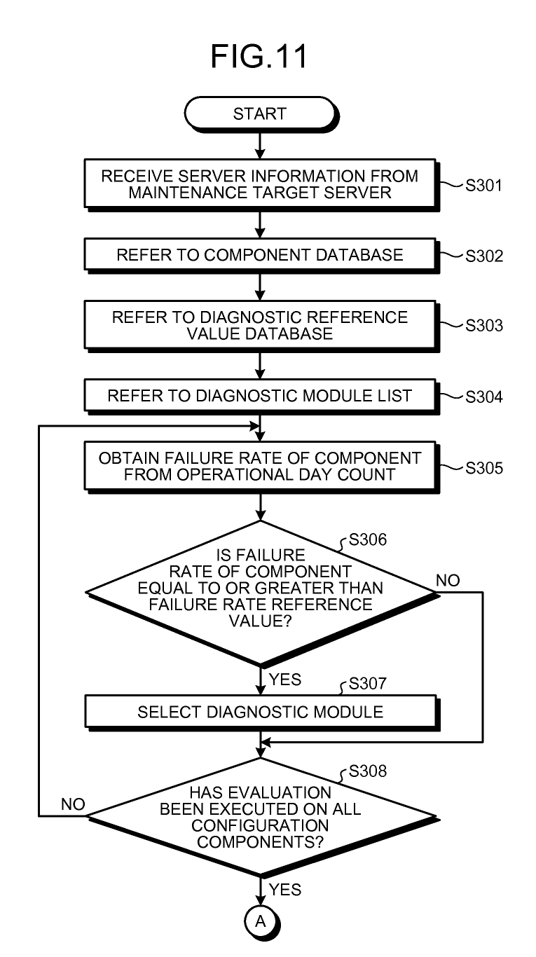

FIGS. 11 to 14 are flowcharts each illustrating the flow of an example of the first process performed by the diagnostic module delivery server 100. As illustrated in FIG. 11, the data transmitting/receiving unit 114 receives the server information transmitted from the maintenance target server 300-2 (Step S301). Then, the diagnostic selecting unit 102 refers to the component database 200, the diagnostic reference value database 104, and the diagnostic module list database 106 (Steps S302, S303, and S304). Then, for the first component in the configuration information 314, the diagnostic selecting unit 102 obtains the failure rate data 202 in the component database 200 by taking into consideration the operational day count that can be obtained from the operational information 316 (Step S305).

The diagnostic selecting unit 102 compares the obtained failure rate with the failure rate reference value that is defined in the diagnostic reference value database 104 (Step S306). If the failure rate is equal to or greater than the failure rate reference value in the diagnostic reference value database 104 (Yes at Step S306), the diagnostic selecting unit 102 selects a diagnostic module from the diagnostic module list database 106 (Step S307). In contrast, if the failure rate is less than the failure rate reference value in the diagnostic reference value database 104 (No at Step S306), the diagnostic selecting unit 102 does not select a diagnostic module but determines whether the evaluation has been executed on all of the components (Step S308).

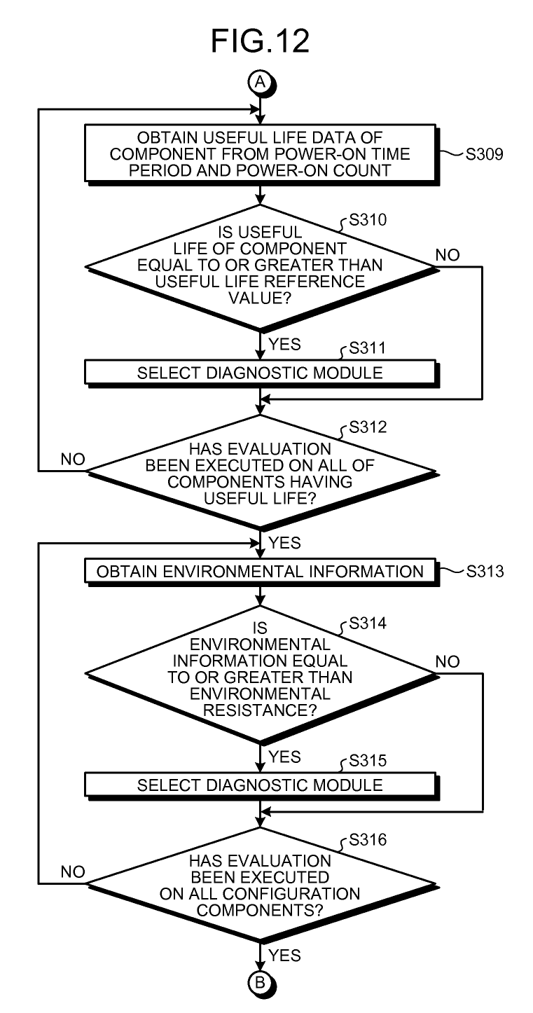

If the diagnostic selecting unit 102 has not completed the evaluation on all of the components (No at Step S308), the diagnostic selecting unit 102 returns to Step S305 and evaluates the next component. In contrast, if the diagnostic selecting unit 102 has completed the evaluation on all of the components (Yes at Step S308), the diagnostic selecting unit 102 moves to the process described with reference to FIG. 12. The diagnostic module selected at the process described with reference to FIG. 11 is as follows.

As illustrated in FIG. 7, because an operational day count is 735 days that is equal to or greater than 2 years, the failure rate data 202 in the component database 200 uses the “total”. Because the total failure rate of the cpu-32 hz-002 of the CPU, i.e., a component, is 1.27 and the failure rate reference value of the CPU is 1.30, the diagnostic module cputest-02 is not selected. Furthermore, because the total failure rate of the dimm-2 g-002 of the memory is 1.39 and the failure rate reference value of the memory is 1.50, the diagnostic module memtest-08 is not selected. Furthermore, because the total failure rate of an hdd-500 g-001 of the HDD is 1.74 and the failure rate reference value of the HDD is 2.00, the diagnostic module hddtest-04 is not selected. Furthermore, because the total failure rate of the dvd-ram-001 of the DVD is 0.81 and the failure rate reference value of the DVD is 1.20, the diagnostic module dvdtest-22 is not selected.

Furthermore, because the total failure rate of the fan-cpu-001 of the FAN is 0.52 and the failure rate reference value of the FAN is 1.00, the diagnostic module fantest-02 is not selected. Furthermore, because the total failure rate of the fan-sys-001 of the FAN is 0.68 and the failure rate reference value of the FAN is 1.00, the diagnostic module fantest-11 is not selected. In contrast, because the total failure rate of the fan-psu-001 of the FAN is 1.01 and the failure rate reference value of the FAN is 1.00, the diagnostic module fantest-23 is selected.

Furthermore, because the total failure rate of the psu-100 v-002 of a power supply unit (PSU) is 0.43 and the failure rate reference value of the PSU is 0.80, the diagnostic module psutest-07 is not selected. In contrast, because the total failure rate of the raid-sas-002 of the HBA is 0.62 and the failure rate reference value of the HBA is 0.50, the diagnostic module raidtest-23 is selected. Furthermore, because the total failure rate of the lan-10 g-001 of the HBA is 0.39 and the failure rate reference value of the HBA is 0.50, the diagnostic module lantest-10 is not selected. Consequently, the diagnostic modules selected at this point are the fantest-23 and the raidtest-23.

In the following, as illustrated in FIG. 12, for the first component in the configuration information 314, the diagnostic selecting unit 102 obtains the useful life data 204 in the component database 200 by taking into consideration the power-on time period and the power-on count that are obtained from the operational information 316 (Step S309). Then, the diagnostic selecting unit 102 compares the obtained useful life data 204 with the useful life reference value defined in the diagnostic reference value database 104 (Step S310). If the useful life data 204 is equal to or greater than the useful life reference value in the diagnostic reference value database 104 (Yes at Step S310), the diagnostic selecting unit 102 selects a diagnostic module from the diagnostic module list database 106 (Step S311). In contrast, if the useful life data 204 is less than the useful life reference value in the diagnostic reference value database 104 (No at Step S310), the diagnostic selecting unit 102 does not select a diagnostic module but determines whether the evaluation has been executed on all of the components (Step S312).

If the diagnostic selecting unit 102 has not completed the evaluation on all of the components (No at Step S312), the diagnostic selecting unit 102 returns to Step S309 and evaluates the next component. In contrast, if the diagnostic selecting unit 102 has completed the evaluation on all of the components (Yes at Step S312), the diagnostic selecting unit 102 moves to the latter processes described with reference to FIG. 12. The diagnostic modules selected during the former processes that have been described with reference to FIG. 12 are as follows.

As illustrated in FIG. 7, the total power-on time period is 5,180 hours and the power-on count is 478. The components having the useful life are the HDD, the FAN, and the PSU. Because the useful life of the power-on time period of the hdd-500 g-001 of the HDD is 45,000 hours and the useful life reference value of the HDD is 70%, the useful life of the HDD converted to a period is 31,500 hours. In contrast, because the total power-on time period of the hdd-500 g-001 of the HDD is 5,180 hours, the diagnostic module hddtest-04 is not selected. Because the useful life of the power-on count of the hdd-500 g-001 of the HDD is 7,500 and the useful life reference value of the HDD is 70%, the useful life of the HDD converted to a count is 5,250 counts. In contrast, because the power-on count of the hdd-500 g-001 of the HDD is 478, the diagnostic module hddtest-04 is not selected.

Because the useful life of the power-on time period of the fan-cpu-001 of the FAN is 53,000 hours and the useful life reference value of the FAN is 80%, the useful life of the FAN converted to a period of time is 42,400 hours. In contrast, because the total power-on time period of the fan-cpu-001 of the FAN is 5,180 hours, the diagnostic module fantest-02 is not selected. Because the useful life of the power-on time period of the fan-sys-001 of the FAN is 53,000 hours and the useful life reference value of the FAN is 80%, the useful life of the FAN converted to a period is 42,400 hours. In contrast, because the total power-on time period of the fan-sys-001 of the FAN is 5,180 hours, the diagnostic module fantest-11 is not selected. Because the useful life of the power-on time period of the fan-psu-001 of the FAN is 45,000 hours and the useful life reference value of the FAN is 80%, the useful life of the FAN converted to a period is 36,000 hours. In contrast, because the total power-on time period of the fan-psu-001 of the FAN is 5,180 hours, the diagnostic module fantest-23 is not selected.

Because the useful life of the power-on time period of the psu-100 v-002 of the PSU is 45,000 hours and the useful life reference value of the PSU is 75%, the useful life of the PSU converted to a period is 33,750 hours. In contrast, because the total power-on time period of the psu-100 v-002 of the PSU is 5,180 hours, the diagnostic module psutest-07 is not selected. Consequently, there is no diagnostic module that is selected by the evaluation related to the useful life and thus the diagnostic modules selected at this time are the fantest-23 and the raidtest-23.

Then, as illustrated in the latter part of the flow illustrated in FIG. 12, for the first component in the configuration information 314, the diagnostic selecting unit 102 obtains the temperature, the humidity, and the vibration from the environmental information 318 (Step S313). Subsequently, the diagnostic selecting unit 102 compares the obtained environmental information 318 with the temperature reference value, the humidity reference value, and the vibration reference value in the diagnostic reference value database 104 (Step S314). If the data on the environmental information 318 is equal to or greater than the temperature reference value, the humidity reference value, and the vibration reference value in the diagnostic reference value database 104 (Yes at Step S314), the diagnostic selecting unit 102 selects a diagnostic module from the diagnostic module list database 106 (Step S315). In contrast, if the environmental information 318 is less than the temperature reference value, the humidity reference value, and the vibration reference value in the diagnostic reference value database 104 (No at Step S314), the diagnostic selecting unit 102 does not select a diagnostic module but determines whether the evaluation has been executed on all of the components (Step S316).

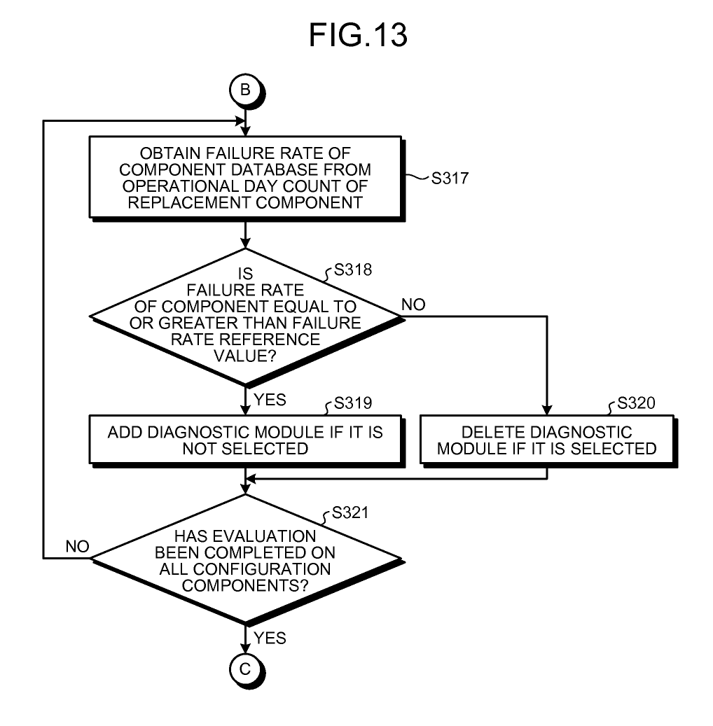

If the diagnostic selecting unit 102 has not completed the evaluation on all of the components (No at Step S316), the diagnostic selecting unit 102 returns to Step S313 and evaluates the next component. In contrast, if the diagnostic selecting unit 102 has completed the evaluation on all of the components (Yes at Step S316), the diagnostic selecting unit 102 moves to the process described with reference to FIG. 13. The diagnostic modules selected during the latter processes described with reference to FIG. 12 are as follows.

As illustrated in FIG. 7, in the maintenance target or the server and the PC, the temperature is 43° C., the humidity is 66%, and the vibration is 4.2 m/s². Because the temperature resistance of the cpu-32 hz-002 of the CPU, which is a component, is 50° C., the cputest-02 is not selected. Furthermore, because the humidity resistance of the cpu-32 hz-002 of the CPU is 80%, the cputest-02 is not selected. Furthermore, because the vibration resistance of the cpu-32 hz-002 of the CPU is 18 m/s², the cputest-02 is not selected. Furthermore, because the temperature resistance of the dimm-2 g-002 of the memory is 60° C., the memtest-08 is not selected. Furthermore, because the humidity resistance of the dimm-2 g-002 of the memory is 65%, the memtest-08 is not selected. Because the vibration resistance of the dimm-2 g-002 of the memory is 38 m/s², the memtest-08 is not selected. If any diagnostic module is selected at the evaluation of the temperature, the humidity, and the vibration, the diagnostics is consequently selected.

Because the temperature resistance of the hdd-500 g-001 of the HDD is 39° C., the hddtest-04 is selected. Because the humidity resistance of the hdd-500 g-001 of the HDD is 75%, the hddtest-04 is not selected. Because the vibration resistance of the hdd-500 g-001 of the HDD is 4 m/s², the hddtest-04 is selected. Because the temperature resistance of the dvd-ram-001 of the DVD is 54° C., the dvdtest-22 is not selected. Because the humidity resistance of the dvd-ram-001 of the DVD is 85%, the dvdtest-22 is not selected. Because the vibration resistance of the dvd-ram-001 of the DVD is 12 m/s², the dvdtest-22 is not selected.

Because the temperature resistance of the fan-cpu-001 of the FAN is 50° C., the fantest-02 is not selected. Because the humidity resistance of the fan-cpu-001 of the FAN is 72%, the fantest-02 is not selected. Because the vibration resistance of the fan-cpu-001 of the FAN is 25 m/s², the fantest-02 is not selected. Because the temperature resistance of the fan-sys-001 of the FAN is 45° C., the fantest-11 is not selected. Because the humidity resistance of the fan-sys-001 of the FAN is 78%, the fantest-11 is not selected. Because the vibration resistance of the fan-sys-001 of the FAN is 25 m/s², the fantest-11 is not selected. Because the temperature resistance of the fan-psu-001 of the FAN is 50° C., the fantest-23 is not selected. Because the humidity resistance of the fan-psu-001 of the FAN is 75%, the fantest-23 is not selected. Because the vibration resistance of the fan-psu-001 of the FAN is 25 m/s², the fantest-23 is not selected.

Because the temperature resistance of the psu-100 v-002 of the PSU is 70° C., the psutest-07 is not selected. Because the humidity resistance of the psu-100 v-002 of the PSU is 85%, the psutest-07 is not selected. Because the vibration resistance of the psu-100 v-002 of the PSU is 28 m/s², the psutest-07 is not selected. Because the temperature resistance of the raid-sas-002 of the HBA is 45° C., the raidtest-23 is not selected. Because the humidity resistance of the raid-sas-002 of the HBA is 75%, the raidtest-23 is not selected. Because the vibration resistance of the raid-sas-002 of the HBA is 25 m/s², the raidtest-23 is not selected. Because the temperature resistance of the lan-10 g-001 of the HBA is 47° C., the lantest-10 is not selected. Because the humidity resistance of the lan-10 g-001 of the HBA is 85%, the lantest-10 is not selected. Because the vibration resistance of the lan-10 g-001 of the HBA is 42 m/s², the lantest-10 is not selected. Consequently, the diagnostic module that is selected at the evaluation related to the environmental resistance is the hddtest-04 and the diagnostic modules that are selected at this stage are the fantest-23, the raidtest-23, and the hddtest-04.

Then, as illustrated in FIG. 13, the diagnostic selecting unit 102 checks whether a replacement component is present by using the latest maintenance history information. If a replacement component is present, the diagnostic selecting unit 102 determines, by using the operational day count (previous maintenance) of the operational information on the server, an operational day count since the maintenance and obtains the failure rate data 202 in the component database 200 (Step S317). Subsequently, the diagnostic selecting unit 102 compares the obtained failure rate data 202 with the failure rate reference value defined in the diagnostic reference value database 104 (Step S318). If the failure rate data 202 is equal to or greater than the failure rate reference value in the diagnostic reference value database 104 (Yes at Step S318), the diagnostic selecting unit 102 selects a diagnostic module if the diagnostic module is not selected for a component targeted for maintenance (Step S319). In contrast, if the failure rate data 202 is less than the failure rate reference value in the diagnostic reference value database 104 (No at Step S318), the diagnostic selecting unit 102 deletes the selection of the diagnostic module if the diagnostic module is selected for a component targeted for maintenance (Step S320).

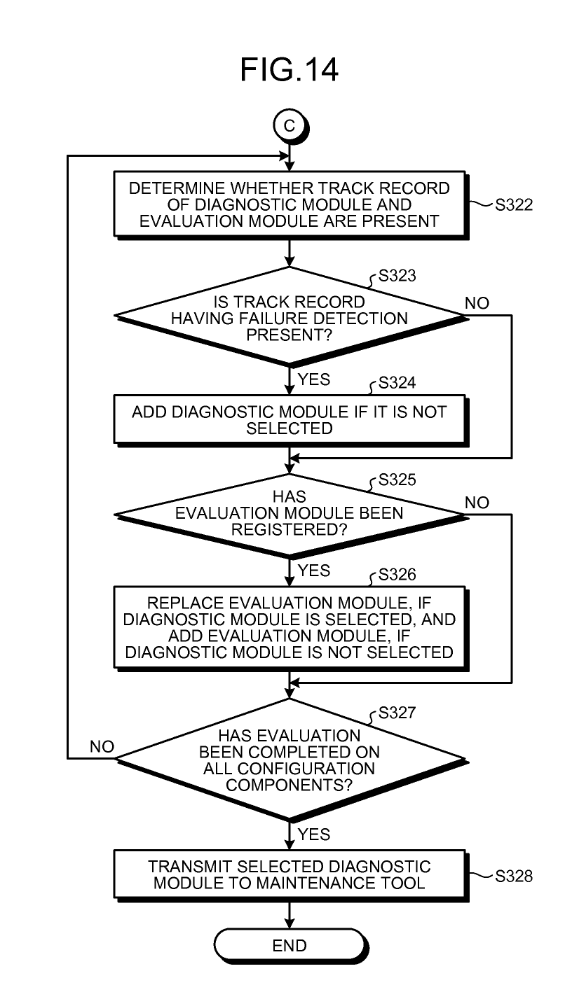

Then, the diagnostic selecting unit 102 determines whether the evaluation has been completed on all of the replacement components (Step S321). If the diagnostic selecting unit 102 has not completed the evaluation on all of the replacement components (No at Step S321), the diagnostic selecting unit 102 returns to Step S317 and evaluates the next replacement component. In contrast, if the diagnostic selecting unit 102 has completed the evaluation on all of the replacement components (Yes at Step S321), the diagnostic selecting unit 102 moves to the process described with reference to FIG. 14. The diagnostic modules that are selected by the processes described with reference to FIG. 13 are as follows.

As illustrated in FIG. 7, because the operational day count after the previous maintenance is 73 days, “3 months” is used from among the component database 200 in the failure rate data 202. The failure rate of the cpu-32 hz-002 of the CPU of the replacement component indicated under “3 months” is 1.32, the failure rate reference value of the CPU is 1.30, and the diagnostic module cputest-02 is not selected; therefore, the diagnostic module cputest-02 is additionally selected. The diagnostic module that is selected at the evaluation related to a replacement component is the cputest-02 and the diagnostic modules that are selected at this stage are the fantest-23, the raidtest-23, the hddtest-04, and the cputest-02.

Then, as illustrated in FIG. 14, the diagnostic selecting unit 102 determines, from the diagnostic module list database 106, whether a registration of an evaluation module and a track record in which a failure of a diagnostic module has been detected is present (Step S322). The diagnostic selecting unit 102 determines whether a track record is present in which a failure has been detected in a diagnostic module associated with a component constituting a server (Step S323). If a track record is present (Yes at Step S323), the diagnostic selecting unit 102 additionally selects a diagnostic module if the diagnostic module is not selected for the component targeted for maintenance (Step S324). The diagnostic selecting unit 102 determines whether an evaluation module associated with a component constituting a server is registered (Step S325). If an evaluation module is registered (Yes at Step S325), the diagnostic selecting unit 102 replaces the evaluation module if the diagnostic module is selected for a component targeted for maintenance. In contrast, if the diagnostic module is not selected, the diagnostic selecting unit 102 additionally selects an evaluation module (Step S326).

Subsequently, the diagnostic selecting unit 102 determines whether the evaluation has been completed on all of the components (Step S327). If the diagnostic selecting unit 102 has not completed the evaluation on all of the components (No at Step S327), the diagnostic selecting unit 102 returns to Step S322 and evaluates the next component. In contrast, if the evaluation has been completed on all of the components (Yes Step S327), the data transmitting/receiving unit 114 transmits the selected diagnostic module to the maintenance target server 300-2 (Step S328) and ends the process. The diagnostic modules selected by the processes described with reference to FIG. 14 are as follows.

As illustrated in FIG. 4, because the track record of the diagnostic module cpu-32 hz-002 of the CPU is represented by yes and the diagnostic module cputest-02 has already been selected, the selection of the diagnostic module cputest-02 remains. Furthermore, because the registration of the evaluation module cpu-32 hz-002 is represented by none, no process is performed thereon. Because the track record of the diagnostic module dimm-2 g-002 of the memory is represented by no, no process is performed thereon. Because the registration of the evaluation module dimm-2 g-002 is represented by none, no process is performed thereon. Because the track record of the diagnostic module hdd-500 g-001 of the HDD is represented by no, no process is performed thereon. Because the registration of the evaluation module hdd-500 g-001 is represented by none, no process is performed thereon. Because the track record on the diagnostic module dvd-ram-001 of the DVD is represented by no, no process is performed thereon. Because the registration of the evaluation module dvd-ram-001 is represented by none, no process is performed thereon.

Furthermore, because the track record of the diagnostic module fan-cpu-001 of the FAN is represented by no, no process is performed thereon. Because the registration of the evaluation module fan-cpu-001 is represented by none, no process is performed thereon. Because the track record of the diagnostic module fan-sys-001 of the FAN is represented by no, no process is performed thereon. Because the registration of the evaluation module fan-sys-001 is represented by none, no process is performed thereon. Because the track record of the diagnostic module of the fan-psu-001 of the FAN is represented by no, no process is performed thereon.

Because the fantest-30 is registered in the evaluation module associated with the fan-psu-001 and the fantest-23 is selected for the diagnostic module associated with the fan-psu-001, the fantest-23 is replaced with the fantest-30.

Furthermore, because the track record of the diagnostic module psu-100 v-002 of the PSU is represented by yes and because no diagnostic module is selected, the psutest-07 is additionally selected. Because the registration of the evaluation module psu-100 v-002 is represented by none, no process is performed thereon. Because the track record of the diagnostic module raid-sas-002 of the HBA is represented by no, no process is performed thereon. Because the registration of the evaluation module raid-sas-002 is represented by none, no process is performed thereon. Because the track record of the diagnostic module lan-10 g-001 of the HBA is represented by no, no process is performed thereon. Because the lantest-20 is registered in the evaluation module associated with the lan-10 g-001 and no diagnostic module is selected, the lantest-20 is additionally selected.

As described above, the psutest-07 and the lantest-20 are additionally selected for the track record of a diagnostic module of a component and for the evaluation of an evaluation module, respectively, and the fantest-30 is replaced with the already selected fantest-23. Consequently, the diagnostic modules that are finally selected are the fantest-30, the raidtest-23, the hddtest-04, the cputest-02, the psutest-07, and the lantest-20. As described above, the selected diagnostic modules are transmitted, as optimized diagnoses, to the maintenance target server 300-2 via the network 400.

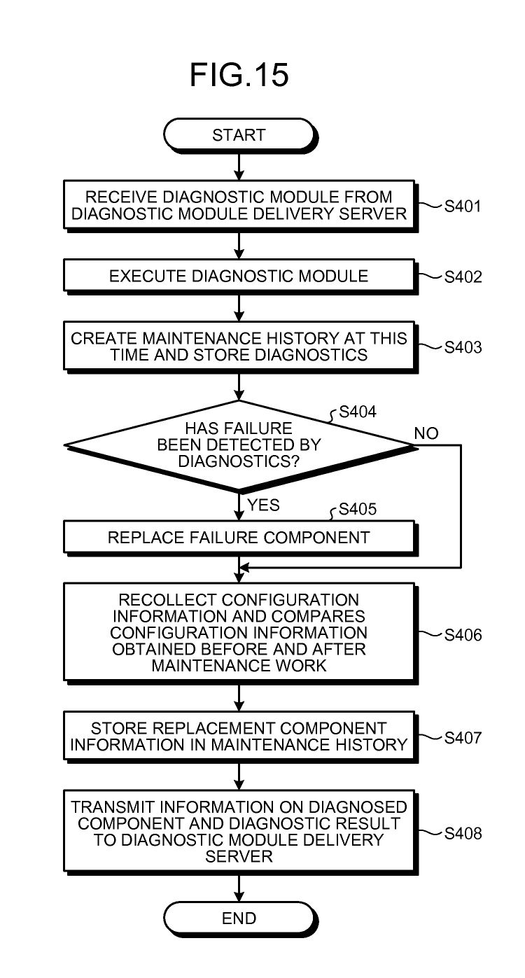

FIG. 15 is a flowchart illustrating the flow of an example of a second process performed by the maintenance target server 300-2. First, the data transmitting/receiving unit 306 receives the diagnostic module that is transmitted from the diagnostic module delivery server 100 (Step S401). Then, the diagnostic control unit 308 executes the diagnostic module on a target component in the maintenance target server 300-2 (Step S402). Subsequently, the maintenance history control unit 310 adds the maintenance history information received this time to the maintenance history stored in the maintenance target server 300-2; reflects the result of the executed diagnostics; and stores it (Step S403). Then, the maintenance history control unit 310 determines whether a failure has been detected by the diagnostics (Step S404).

If a failure is detected (Yes at Step S404), the maintenance history control unit 310 replaces the component in which the failure has been detected (Step S405).

Then, the maintenance history control unit 310 recollects the configuration information on the server and compares it with the configuration information that has been collected before the maintenance work (Step S406). Subsequently, based on the result obtained at Step S405, the maintenance history control unit 310 identifies the replacement component, reflects the replacement component information to the maintenance history, and stores it (Step S407). Lastly, the maintenance history control unit 310 transmits, to the diagnostic module delivery server 100 via the network 400, information on the component diagnosed during the maintenance work executed at this time, diagnostic module information, and the diagnostic result (Step S408).

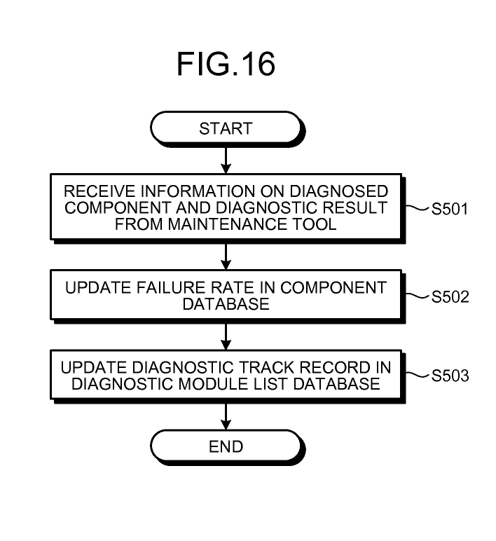

FIG. 16 is a flowchart illustrating the flow of an example of the second process performed by the diagnostic module delivery server. The data transmitting/receiving unit 114 receives the result of the maintenance work transmitted from the maintenance target server 300-2 (Step S501). Then, based on the result of the maintenance work obtained this time in addition to the already received configuration information and operational information on the maintenance target server 300-2, the DB updating unit 108 updates the failure rate data 202 on the component registered in the component database 200 (Step S502). Furthermore, from the diagnostic module and the diagnostic result, the DB updating unit 108 updates the diagnostic module list database 106 (Step S503). Specifically, the DB updating unit 108 performs an update process such that the DB updating unit 108 updates the track record in the diagnostic module list database 106 or, if a diagnostic module executed as an evaluation module detects a failure, the DB updating unit 108 registers the evaluation module as an authoritative diagnostic module.

As described above, the diagnostic module delivery device and the diagnostic module delivery method according to the embodiment can execute the diagnostics conforming to the actual failure rate or the past diagnostic track record of a component of a device that is targeted for maintenance. Consequently, the diagnostic module delivery device and the diagnostic module delivery method according to the embodiment can properly determine whether diagnostics is executed on a component of a device that is targeted for maintenance. Furthermore, with the diagnostic module delivery device and the diagnostic module delivery method according to the embodiment, instead of a typical statistical value, diagnostics is selected based on the actual fault rate of components including a component that has been replaced; therefore, it is possible to execute the diagnostics conforming to the current condition of a device targeted for maintenance. Furthermore, with the diagnostic module delivery device and the diagnostic module delivery method according to the embodiment, by executing the diagnostics conforming to a state of a device targeted for maintenance, unwanted diagnostics can be skipped. Consequently, efficient diagnostics can be executed during maintenance work.

Furthermore, the diagnostic module delivery device and the diagnostic module delivery method according to the embodiment can execute diagnostics conforming to the operation state, the installation environment, and the maintenance history of a device targeted for maintenance. Consequently, the diagnostic module delivery device and the diagnostic module delivery method according to the embodiment can properly determine whether diagnostics is executed on a component of a device targeted for maintenance.

Furthermore, with the diagnostic module delivery device and the diagnostic module delivery method according to the embodiment, because a diagnostic module is not previously included in a maintenance tool, the diagnostic module can be revised without revising the maintenance tool. Furthermore, because the diagnostic module delivery device and the diagnostic module delivery method according to the embodiment update a diagnostic module or evaluate a diagnostic module, efficient diagnostics conforming to the latest component can be executed. Furthermore, with the diagnostic module delivery device and the diagnostic module delivery method according to the embodiment, an update of the database with respect to a replacement component can be performed by a maintenance technician when maintenance is carried out. Consequently, it is possible to prevent an erroneous update due to an input error.

In the embodiment, a description has been mainly given of the diagnostic module delivery device and the diagnostic module delivery method; however, the embodiment is not limited thereto. For example, a function that is the same as that performed in the above described embodiment can be implemented by a diagnostic module delivery program prepared in advance and executed by a computer. Specifically, the diagnostic module delivery program is implemented by the computer reading, from a component database that stores therein values related to the reliability of components obtained based on maintenance history of components constituting a device that is targeted for maintenance, a value related to the reliability of a component of the device targeted for the maintenance. Furthermore, the diagnostic module delivery program is implemented by the computer determining whether to diagnose the component in accordance with a result of comparing the read value related to the reliability of the component and a previously set threshold. Furthermore, the diagnostic module delivery program is implemented by the computer transmitting, to the device targeted for the maintenance, a diagnostic module that is used to diagnose the component in which it is determined that diagnostics is performed. The diagnostic module delivery program can be delivered to the computer via a communication network, such as the Internet. Furthermore, the information processing program may also be stored in a computer readable recording medium, such as a memory, and a hard disk, and be implemented by the computer reading the program from the recording medium.

According to an aspect of the diagnostic module delivery device disclosed in the embodiments, an advantage is provided in that it is possible to appropriately determine whether diagnostics is executed on a component based on maintenance history of the component constituting a device targeted for maintenance.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A diagnostic module delivery device comprising:
a memory; and
a processor coupled to the memory, wherein the processor executes a process comprising:
reading, from a component database that stores therein values related to the reliability of components and obtained based on maintenance history of the components constituting a device that is targeted for maintenance, a value related to the reliability of a component of the device targeted for the maintenance, and determining whether to diagnose the component in accordance with a result of comparing the read value related to the reliability and a previously set threshold; and
transmitting, to the device targeted for the maintenance, a diagnostic module that is used to diagnose the component in which it is determined, at the determining, that diagnostic is to be performed.

2. The diagnostic module delivery device according to claim 1, wherein the values related to the reliability of the components stored in the component database contain a failure rate of a component obtained based on the maintenance history of the components or contain a useful life value of a component obtained based on the maintenance history of the components.

3. The diagnostic module delivery device according to claim 1, further comprising a diagnostic module list database that stores therein, for each component constituting the device targeted for the maintenance, an identifier of the diagnostic module and the presence or absence of a track record of failure detection of the diagnostic module, wherein
when the track record of the failure detection of the diagnostic module is present in the diagnostic module list database and when the diagnostic module is not selected for diagnosing the component, the determining includes adding the diagnostic module that is to be used to diagnose the component.

4. The diagnostic module delivery device according to claim 1, further comprising:
first receiving, from the device targeted for the maintenance, maintenance history information containing the presence or absence of replacement of the components constituting the device targeted for the maintenance; and
updating, based on the maintenance history information received at the first receiving, the values related to the reliability of the components stored in the component database.

5. The diagnostic module delivery device according to claim 2, further comprising:
second receiving, from the device targeted for the maintenance, component information, which identifies the components constituting the device targeted for the maintenance, and environmental information, which contains temperature information or humidity information on the location where the device targeted for the maintenance is set up or contains vibration information on the device targeted for the maintenance; and
storing, as the threshold, a failure rate reference value, a useful life reference value, a temperature reference value, a humidity reference value, or a vibration reference value, wherein
the reading includes reading, from the component database, a failure rate or the environmental information of a component that is associated with the component information received at the second receiving, and the determining includes determining whether to diagnose the component in accordance with a result of comparing the read failure rate or the read environmental information with the failure rate reference value or the useful life reference value, respectively, stored in the diagnostic reference value database, or of comparing the temperature information, the humidity information, or the vibration information received at the second receiving with the temperature reference value, the humidity reference value, or the vibration reference value, respectively, stored in the diagnostic reference value database.

6. The diagnostic module delivery device according to claim 5, wherein
the second receiving further includes receiving, from the device targeted for the maintenance, operational information containing an operational day count of the device targeted for the maintenance, and
the reading includes reading, from the component database that stores therein a plurality of failure rates of the components in accordance with the operational day count of the device targeted for the maintenance, a failure rate of a component associated with the operational day count that is received at the second receiving, and the determining includes determining whether to diagnose the component in accordance with a result of comparing the read failure rate of the component with the failure rate reference value stored in the diagnostic reference value database.

7. The diagnostic module delivery device according to claim 5, wherein
the second receiving further includes receiving, from the device targeted for the maintenance, operational information containing a power-on time period or a power-on count of the device targeted for the maintenance,
the storing includes storing, as the useful life reference value, a percentage of the power-on time period or the power-on count, and
the determining includes determining whether to diagnose the component in accordance with a result of comparing the power-on time period or the power-on count received at the second receiving with a value obtained by multiplying the useful life value that is read from the component database by the percentage of the useful life reference value.

8. The diagnostic module delivery device according to claim 5, wherein
the second receiving further includes receiving, from the device targeted for the maintenance, maintenance history information containing the presence or absence of replacement of the components constituting the device targeted for the maintenance and operational information containing an operational day count for which the device targeted for the maintenance has been operated since previous maintenance, and
the determining includes determining, based on the maintenance history information received at the second receiving, whether replacement of a component is present, reading, when the replacement of the component is present from the component database that stores therein a plurality of failure rates of the components in accordance with the operational day count of the device targeted for the maintenance, a failure rate of a component associated with the operational day count that is counted since the previous maintenance and that is received at the second receiving, and determining whether to diagnose the component in accordance with the result of the comparison.

9. A diagnostic module delivery method comprising:
reading, from a component database that stores therein values related to the reliability of components and obtained based on maintenance history of the components constituting a device that is targeted for maintenance, a value related to the reliability of a component of the device targeted for the maintenance, and determining whether to diagnose the component in accordance with a result of comparing the read value related to the reliability and a previously set threshold, using a processor; and
transmitting, to the device targeted for the maintenance, a diagnostic module that is used to diagnose the component in which it is determined, at the determining, that diagnostic is to be performed, using the processor.

10. A computer-readable recording medium having stored therein a program that causes a computer to execute a diagnostic module delivery process comprising:
reading, from a component database that stores therein values related to the reliability of components and obtained based on maintenance history of the components constituting a device that is targeted for maintenance, a value related to the reliability of a component of the device targeted for the maintenance, and determining whether to diagnose the component in accordance with a result of comparing the read value related to the reliability and a previously set threshold; and
transmitting, to the device targeted for the maintenance, a diagnostic module that is used to diagnose the component in which it is determined, at the determining, that diagnostic is to be performed.
